(19) United States
(12) Patent Application Publication
(10) Pub. No.: US 2010/0235228 A1
(43) Pub. Date: Sep. 16, 2010

(54) Service provider evaluation and feedback collection and rating system

(76) Inventor: Octavio Torress, San Diego, CA (US)

Correspondence Address: GARY L. EASTMAN, Gary L. Eastman, APLC, 401 W. "A" Street, Suite 1785, SAN DIEGO, CA, 92101, US

(21) Appl. No.: 12/657,299

(22) Filed: Jan. 14, 2010

Related U.S. Application Data
(60) Provisional application No. 61/205,162, filed on Jan. 14, 2009.

(51) Int. Cl. G06Q 10/00; G06Q 50/00; G06F 3/048; G06F 15/16

(52) U.S. Cl. 705/11; 705/347; 705/317; 715/780; 709/203

(57) ABSTRACT

The service provider feedback collection and rating system of the present invention includes a system to quantify the quality of the service in the care industry. The system provides patients and their families the information they need to make an informed decision regarding the care for their loved one by identifying standards for the particular service industry, compares adherence to those standards between care providers. The system provides for a care provider to create its own professional profile listing all of its standards, policies, procedures, employee turnover, performance, and other criteria it feels may be important to prospective clients, and customers of the care provider to evaluate the accuracy of the care provider's profile, as well as provide comments and reviews of their experiences with that care provider. This information, when considered as a whole, is then used to create a care providing rating. Prospective customers can then easily compare the ratings from various care providers.

### RELATED APPLICATIONS

This application claims the benefit of priority to United States Provisional Patent Application entitled “Service Provider Evaluation and Feedback Collection and Rating System”, filed Jan. 14, 2009, assigned Ser. No. 61/205,162, and currently co-pending.

### FIELD OF THE INVENTION

The present invention relates generally to the field of customer service and the ratings of those services. The present invention is more particularly, though not exclusively, useful as an internet-based home-health-care rating system that provides for service provider self evaluations and customer evaluations, and an overall rating based thereon.

### BACKGROUND OF THE INVENTION

One of the most frightening events in a patient's life is his realization that he can no longer take care of himself. While this condition can often be temporary, it can also become a long-term condition, perhaps lasting through the remainder of a patient's life. When a patient is no longer capable of taking care of himself, he may require the round-the-clock assistance of trained medical staff in a medical facility or nursing home, a brief stay in an assisted-living facility, or perhaps he may only require a once-a-day visit for assistance with bathing and dressing. In any case, this assistance represents a significant change in the patient's daily routine, and a disruption to the family of the patient.

Regardless of the type of patient care that is needed, it is very important to the patient and his family to find the best possible care for their budget. With medical costs rising, and medical insurance providers limited coverage for assisted living options, it is typically the responsibility of the patient and his family to determine what option is best for the family, and what facility they will choose as their care provider.

In order for the patient and his family to make the best decision regarding the patient's short or long term care options, they often painstakingly review the qualifications of each potential care provider. Unfortunately, most often the only available data is disseminated by the care provider itself, and undoubtedly contains some bias. Moreover, the care providers will likely never identify their failures, such as high staff turnover, poor customer satisfaction, insurance coverage issues, low performance standards, employee reviews, or the absence of qualifications and testing of their employees.

In some cities, third party information is available for some care providers. This information may be provided by local organizations, such as the local chapter of the Better Business Bureau. While these databases serve to collect and report grievances with a particular company, they do not regularly list the qualifications, training, or certifications of those companies. As a result, it is no surprise that the patients and their families are often frustrated by this evaluation and decision-making process when choosing a care provider for their loved one.

In light of the above, it would be advantageous to provide a system that provides patients and their families the information they need to make an informed decision regarding the care for their loved one. It would also be advantageous to provide a system that identifies standards for the particular service industry, and provides a manner to compare adherence to those standards between care providers. It would also be advantageous to provide a system that provides for a care provider to create its own professional profile listing all of its standards, policies, procedures, employee turnover, performance, and other criteria it feels may be important to prospective clients. Likewise, it would be advantageous to provide a system that would allow customers of the care provider to evaluate the accuracy of the care provider's profile, as well as provide comments and reviews of their experiences with that care provider. Further, it would be advantageous to provide a system that would analyze the care provider's ratings, the customer's ratings, and provide a single overall rating of the care provider.

### SUMMARY OF THE INVENTION

The service provider feedback collection and rating system of the present invention includes a system to quantify the quality of the service in the care industry. The system provides patients and their families the information they need to make an informed decision regarding the care for their loved one by identifying standards for the particular service industry, and comparing adherence to those standards between care providers. The system provides for a care provider to create its own professional profile listing all of its standards, policies, procedures, employee turnover, performance, and other criteria it feels may be important to prospective clients. This data is evaluated and a provider rating is determined. Customers of the care provider create a profile and evaluate the accuracy of the care provider's profile, as well as provide comments and reviews of their experiences with that care provider. This data is evaluated and a customer rating is determined. The provider rating and the customer ratings, when considered as a whole, are then used to create an overall care provider rating. Prospective customers can then easily compare the ratings from various care providers by comparing their overall rating scores.

In determining the ratings for each care provider, open-ended questions about the care industry are asked of the care provider business owners, such as via an online questionnaire or printed questionnaire. The answers to these questions are then weighted and used to form algorithms that give a “Provider” rating to that care business. The open-ended questions were created to form a minimum standard and rate non-licensed and licensed care businesses. The rating of licensed facilities seems redundant on a minimum standard (or licensure) basis, however; the open-ended questions deviate from the norm and are relevant to the other functions on the website. This “Provider” rating is then posted to a website.

In addition to the provider-based questions, questions are presented to customers and clients of these care provider businesses to form another set of algorithms that result in a separate “Customer” rating. These questions relate to the customer's overall satisfaction, the care provider's adherence to their own standards, the standards of the industry, etc., and may be asked through a website or a printed questionnaire. The “Customer” rating from these questions is then posted alongside the “Provider” rating from that specific care provider business.

Once the Provider rating and Customer ratings are accumulated, these two ratings are then combined to develop an Overall rating. Weight of the Customer ratings influence the Overall rating so even if a business answers all the questions optimally, if their service is less than standard, it will be reflected in a lower overall rating. These three separate ratings, Provider, Customer and Overall, may be posted together on the same webpage so that the general public can quickly assess the best quality of service from a care provider. This saves them a great deal of time and gives convenience and peace-of-mind when put into a situation where are care giver is needed for a loved one. This is particularly useful when a family must make a hasty decision; such as when faced the unexpected illnesses of an accident, stroke, or heart attack.

Currently, as a patient is released from a hospital or primary care provider, they are provided with a list of secondary care providers available in the region. Unfortunately, most institutions are precluded from giving anything other than basic contact information for a care provider out of the fear that any negative information would be the basis of a lawsuit by the care provider. Also, should the institution provide positive information for a particular care provider, and the patient is somehow mistreated, the patient or his family may sue as a result of the mis-information. As a result, leaving a primary care facility is just the start of the headache of identifying and selecting a secondary care provider.

The system of the present invention eliminates the challenges that a patient would otherwise experience when a patient leaves the hospital with a list of care providers to contact, and has to rely on word of mouth or gamble with the care givers supplied to them from the hospital. The present invention provides primary care providers, such as a Hospital, a tool to assist patients in the arduous task of quantifying the quality of service the care provider businesses and or other companies they are recommending to a discharged patient. The system of the present invention shows the true service quality of the care providers because the customers from the businesses leave comments and rate those businesses. For families and individuals needing a care giver, this is a much needed tool to ease the selection process of many caregivers in their local area.

### BRIEF DESCRIPTION OF THE DRAWINGS

The aforementioned and other advantages of the service provider feedback collection and rating system of the present invention will become more apparent to those skilled in the art upon making a thorough review and study of the following detailed description of the invention when reviewed in conjunction with the drawings in which like references numerals refer to like parts, and wherein:

FIG. 1 is a diagram showing the service provider feedback collection and rating system of the present invention including a central server having a memory storage device, in communication with a number of service providers, and accessible to a number of customer computers, all interconnected via the Internet;

FIG. 2 is a block diagram of the service provider feedback collection and rating system of the present invention showing a central server in electrical communication with multiple provider and customer pairs enabling communication between each provider and the central server, and each customer and the central server;

FIG. 3 is a flow chart of the service provider feedback collection and rating system of the present invention, wherein the care provider data is collected from the care provider, and a provider rating is determined;

FIG. 4 is a flow chart of the service provider feedback collection and rating system of the present invention, wherein the customer data for a particular service provider is collected and a customer rating is determined;

FIG. 5 is a flow chart of the service provider feedback collection and rating system of the present invention, wherein the provider rating and the customer rating are combined to calculate the overall rating for the service provider;

FIG. 6 is a flow chart of the service provider feedback collection and rating system of the present invention, wherein a potential customer generates an exemplary search query for service providers and the database of service providers is passed through the query to generate a list of provider profiles matching the query;

FIG. 7 is a representative provider questionnaire of the service provider feedback collection and rating system of the present invention to be completed by a service provider and submitted to the central processor to generate a provider profile, and utilized to determine a provider rating for that provider;

FIG. 8 is a representative customer search query used to specify preferences of a prospective customer using the service provider feedback collection and rating system of the present invention to identify service providers of interest;

FIG. 9 is a representative customer questionnaire of the service provider feedback collection and rating system of the present invention to be completed by a customer after utilizing the services of a service provider, and is utilized to determine a customer rating for that care provider;

FIG. 10 is a representative display of the service provider feedback collection and rating system of the present invention showing the search results from a customer query, identifying the service provider, the provider rating, the customer rating, and the overall rating for that service provider, as well as the provider's star rating to provide quick and easy interpretation of the customer query results;

FIG. 11 is a representative summary of the service provider feedback collection and rating system of the present invention in which the specific care provider's questionnaire data is available for review and further evaluation by a prospective customer;

FIG. 12 is a representative summary of the service provider feedback collection and rating system of the present invention in which a customer's questionnaire data and response is available for review and further evaluation by a prospective customer, and includes an identifier to signal that a Blog entry was made by this reporting customer;

FIG. 13 is a representative BLOG entry from the service provider feedback collection and rating system of the present invention showing a customer BLOG entry, a Professional BLOG entry, and the cumulative BLOG entries related to a single service provider viewable by a potential or existing customer; and

FIG. 14 is a representative professional page detailing the favorite care providers of the professional as well as those care providers that are not recommended.

### DETAILED DESCRIPTION OF A PREFERRED EMBODIMENT

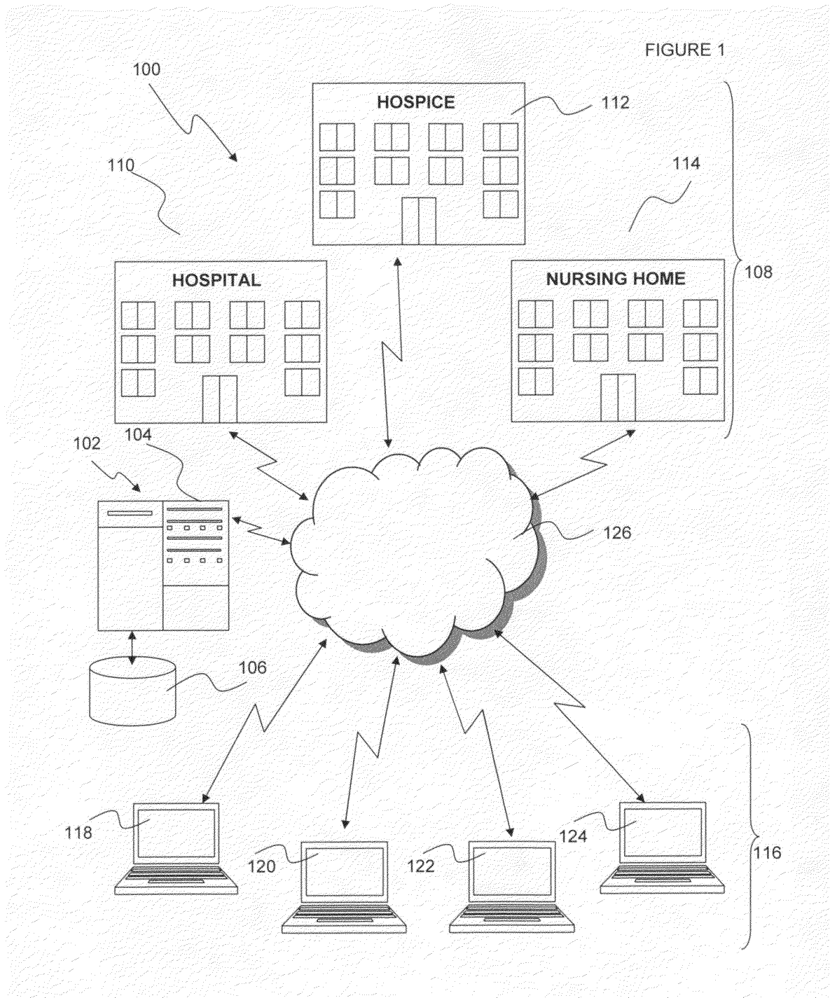

Referring initially to FIG. 1, a diagram showing the service provider feedback collection and rating system of the present invention is shown and generally designated 100. System 100 includes a central server 102 having a central processing unit (CPU) 104 and a memory storage device 106. Central processing unit 104 is of a configuration as generally known in the art and capable of performing the tasks specified herein. Further, memory storage device 106 may include any combination of random access memory (RAM), static read only memory (ROM), solid state, magnetic, and optical media types as is known in the art.

A collection of service providers 108, and a number of customer computers 116 may all be interconnected via the Internet 126. Specifically, a hospital 110, hospice 112 and nursing home 114 are generally referred to as service providers 108. These service providers, though specifically identified, are merely intended to represent typical service providers, including but not limited to in-home nurses, adult day care providers, outpatient medical facilities, inpatient medical facilities, and the like.

A number of customer computers 118, 120, 122 and 124 are connected to the internet 126. In this configuration, each of the customer computers may independently connect to the central server 102, and to each care provider 110, 112, and 114. While the Internet has been described as a preferred method of communication between the various components of the service provider feedback collection and rating system of the present invention, such description is not limited. Rather, it is to be appreciated that any communication technique known in the art is fully contemplated herein.

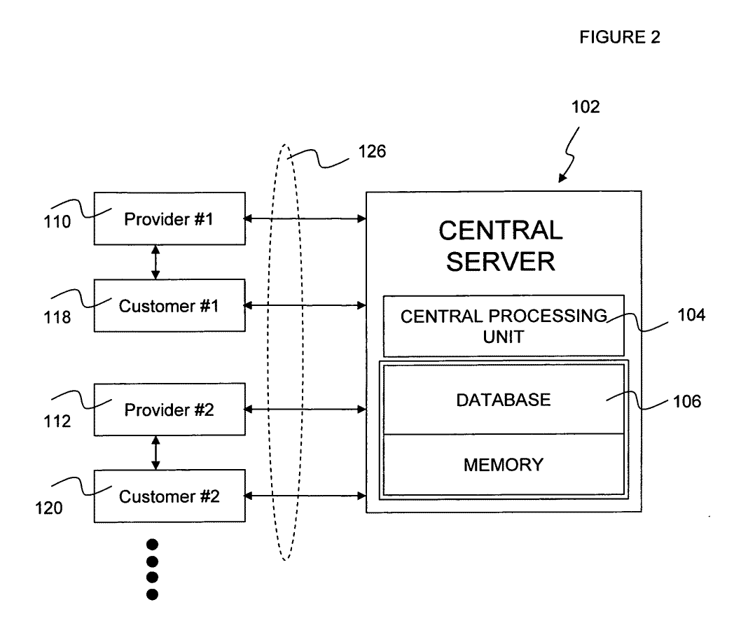

FIG. 2 shows a block diagram of the service provider feedback collection and rating system 100 of the present invention and shows central server 102 in electrical communication with multiple provider 110, 112 and customer 118, 120 pairs enabling communication between each provider and the central server, and each customer and the central server. The internet connection of a preferred embodiment is shown by dashed lines 126, and represents a communication channel between the various components of system 100.

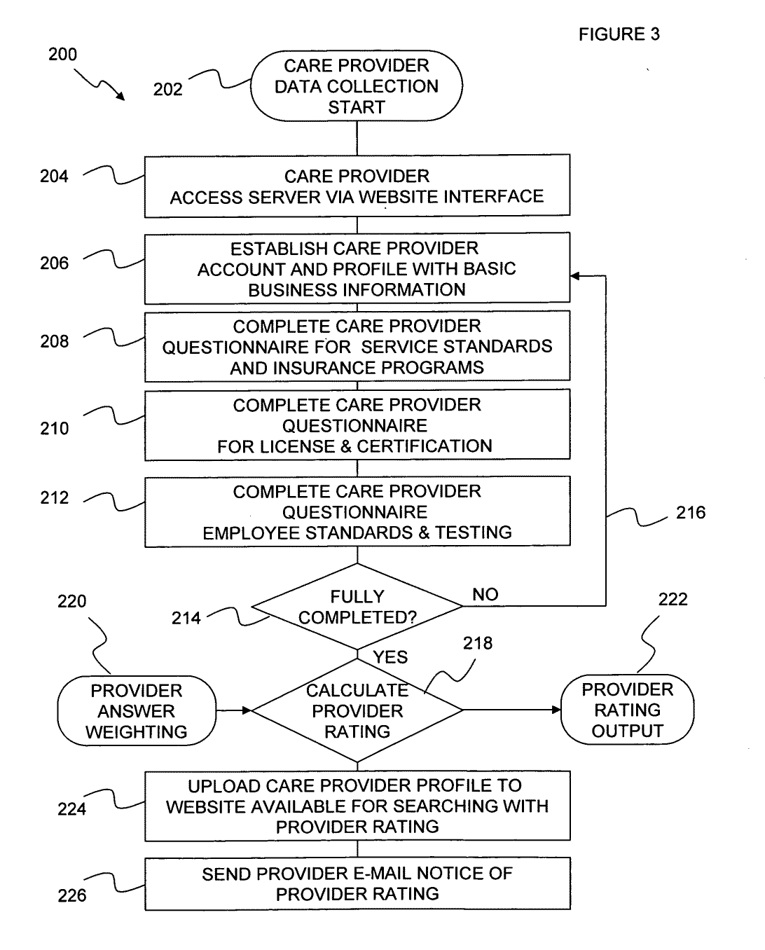

The service provider feedback collection and rating system of the present invention requires the collection of data from its member service providers. This data may be obtained through a questionnaire to be completed by the service provider itself. FIG. 3 includes a flow chart 200 of the method of the service provider feedback collection and rating system of the present invention, wherein the care provider data is collected from the care provider, and a provider rating is determined.

Care provider data collection begins in step 202, and a care provider then accesses the central server in stem 204. Once a care provider account and profile is established with basic business information in step 206, a questionnaire for service standards and insurance information is completed in step 208. Licensing and certification questions for the service provider are answered in step 210, and questions related to the employee standards and testing are completed in step 212.

Following completion of the various data fields of steps 204-212, method 200 verifies in step 214 that the questionnaire is fully completed. If the questionnaire is not completed, method 200 returns to step 206 to complete the process. If the questionnaire is completed, the provider rating is calculated in step 218. In order for the calculation to be performed, the provider answer weighting must be provided from source 220.

Provider answer weighting is a mathematical weighting of various answers provided by the care provider based on the relative importance of those answers. For instance, a low number of years in business may be weighted far less than whether the care provider has ever been sued and found liable for negligence. In fact, some answers from the questionnaire may be weighted far more than other answers, with the weighting to be determined by the relative importance of those factors.

Because the provider answer weighting is provided at the time of calculating the provider rating in step 218, it is very easy to adjust the weighting at any time. In this case, the care provider rating for all care providers may reflect the most current answer weighting.

Once the provider rating is calculated in step 218, the provider rating is made available in output 222. Also, the care provider rating is uploaded to the care provider profile in step 224 on the central server, and is now available for searching by others. In some cases, it may also be advantageous to provide an email notification to the care provider in step 226 to notify it with its current customer rating.

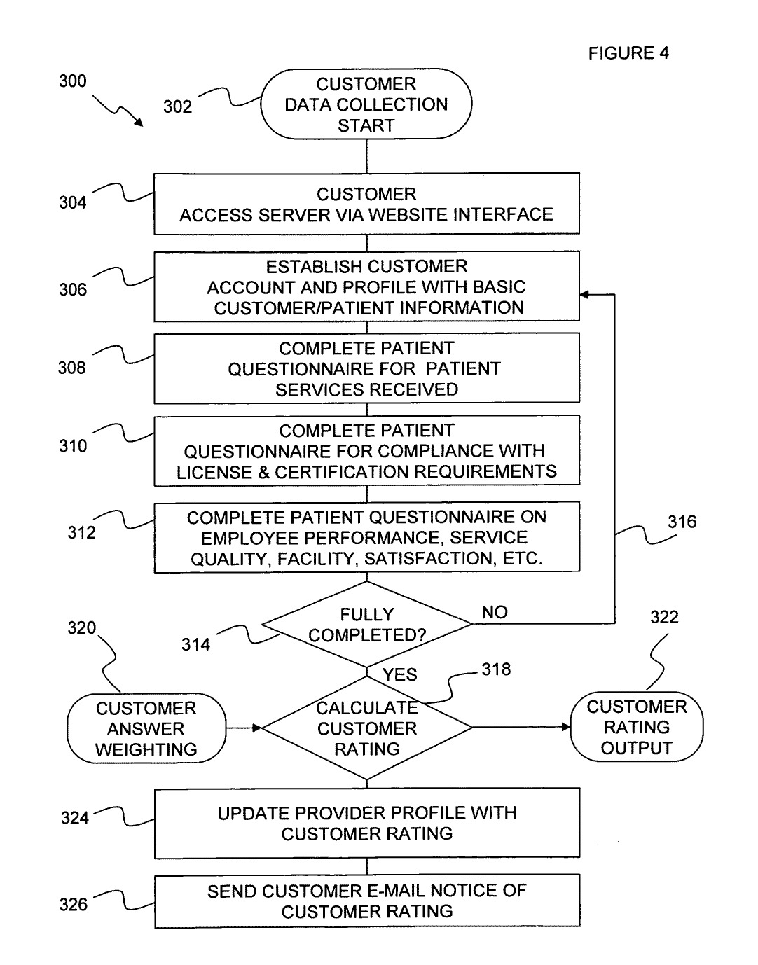

Referring to FIG. 4 is a flow chart 300 of the method of service provider feedback collection and rating system 100 of the present invention, wherein the customer data for a particular service provider is collected and a customer rating is determined. Customer data collection starts in step 302 and includes the customer accessing the central server via a website interface available over the internet, in step 304. The customer in step 306 establishes a customer account and profile with basic customer and patient information.

Once the patient profile is established in step 306, a service provider is identified and a patient questionnaire is completed in steps 310 and 312. Specifically, in step 310 the patient answers questions related to the care provider's compliance with license and certification requirements, and in step 312, the patient answers questions related to the services received, such as employee performance, service quality, facility, and satisfaction, etc.

When step 312 is completed, flow chart 300 verifies that the questionnaire is completed in step 314, and if it is not complete, returns to step 306. If the questionnaire has been completed in step 314, the customer rating is calculated in step 318.

Customer answer weighting is a mathematical weighting of various answers provided by the customer based on the relative importance of those answers. For instance, the newness of a facility may be weighted far less than the competence of the employees of the care provider. In fact, some answers from the questionnaire may be weighted far more than other answers, with the weighting to be determined by the relative importance of those factors.

Because the customer answer weighting is provided at the time of calculating the customer rating in step 318, it is very easy to adjust the weighting at any time. In this case, the customer rating for all customers may reflect the most current answer weighting.

Once the customer rating is calculated in step 318, the customer rating is made available in output 322. Also, the customer rating is uploaded to that care provider profile in step 324 on the central server, and is now available for searching by others. In some cases, it may also be advantageous to provide an email notification to the customer in step 326 to notify it with its recent customer rating.

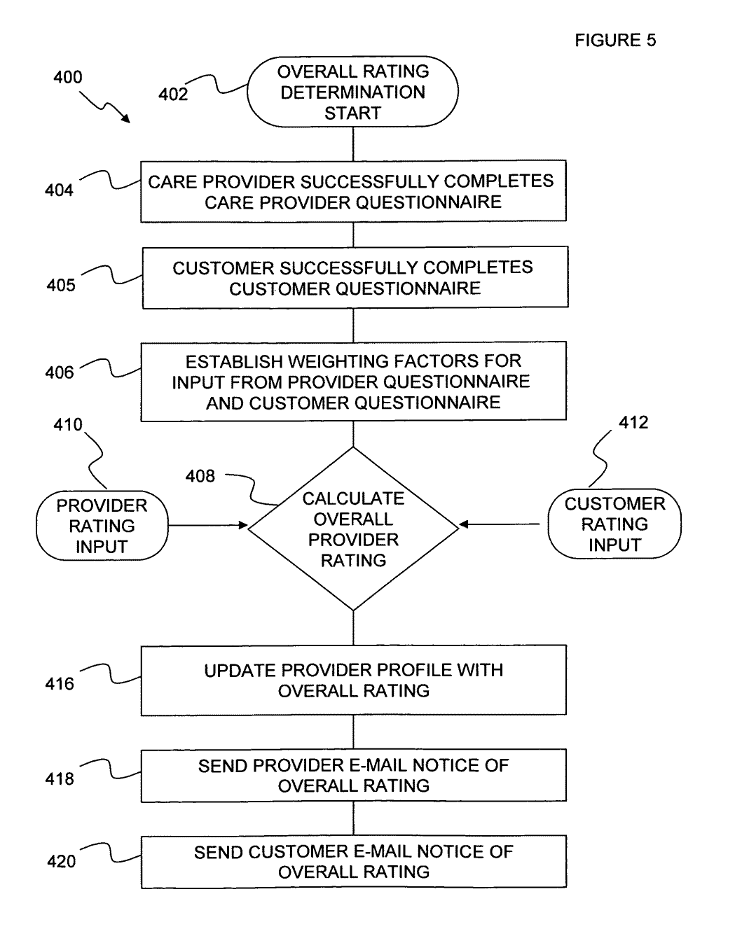

Referring to FIG. 5, flow chart 400 depicts the determination of the overall care provider rating, and begins with step 402. Once a care provider successfully completes the customer questionnaire in step 404, and at least one customer successfully completes the customer questionnaire in step 405, method 400 determines the weighting factors for the overall rating in step 406.

In a preferred embodiment of the present invention, the weighting factors for the provider rating and customer rating may vary depending on the specific criteria being evaluated. For instance, in cases where there are only a few customer ratings, these ratings may be given little weight since a single customer would have too large an influence on the overall rating of the care provider. On the other hand, in cases where there are many customer ratings, it may be advantageous to increase the weight of the customer ratings based on the large number of contributors to that customer rating.

Once the weighting factors have been determined in step 406, the provider rating input is provided from 410, the customer rating input is provided from 412, and the calculation of the overall provider rating is completed in step 408. The overall rating is then updated to the provider profile in step 416, and in some cases, an email reporting the overall rating may be sent to the provider in step 418, and to the customer in step 420.

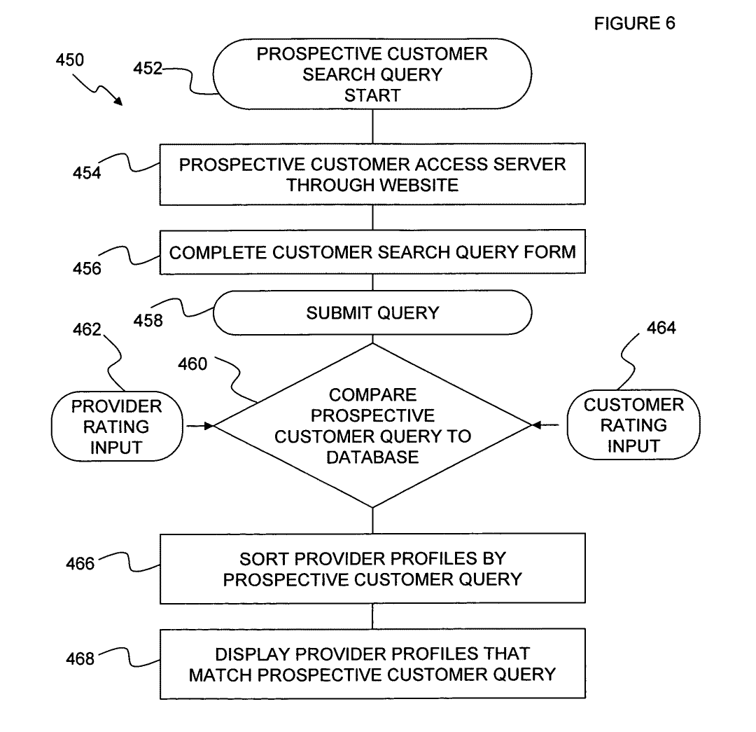

Referring now to FIG. 6, a flow chart 450 of the service provider feedback collection and rating system of the present invention is shown and depicts the customer generating a search query for service providers. Specifically, method 450 begins in step 452 and a prospective customer accesses the central server through a website interface in step 454. The customer then completes a customer query form in step 456, and that query form is submitted in step 458.

The method 450 receives the provider rating inputs 462, the customer rating inputs 464, and in step 460, compares the prospective customer query to the database of service providers. The results of this comparison should, in most cases, include a number of prospective services providers. The list of those prospective service providers is sorted in step 466, and then displayed for the customer in step 468.

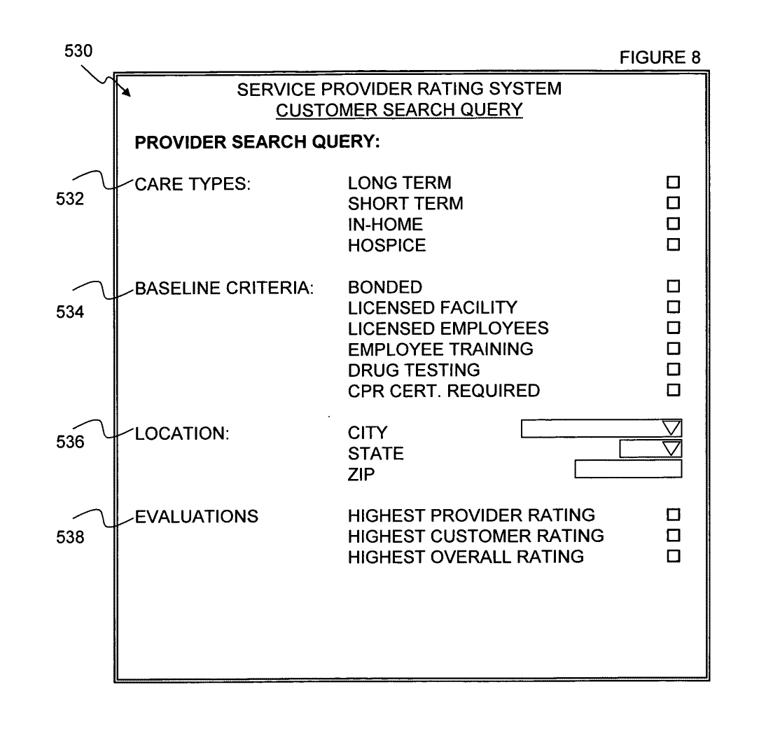

The customer receives the results of the query which includes a list of the various care providers that match the specific query. As will be described in greater detail in conjunction with FIG. 8, a prospective customer may utilize a variety of data fields for searching, may prioritize the important aspects of a care provider's business, and may identify specific mandatory fields for any possible care provider.

### Exemplary Input Questionnaires & Queries

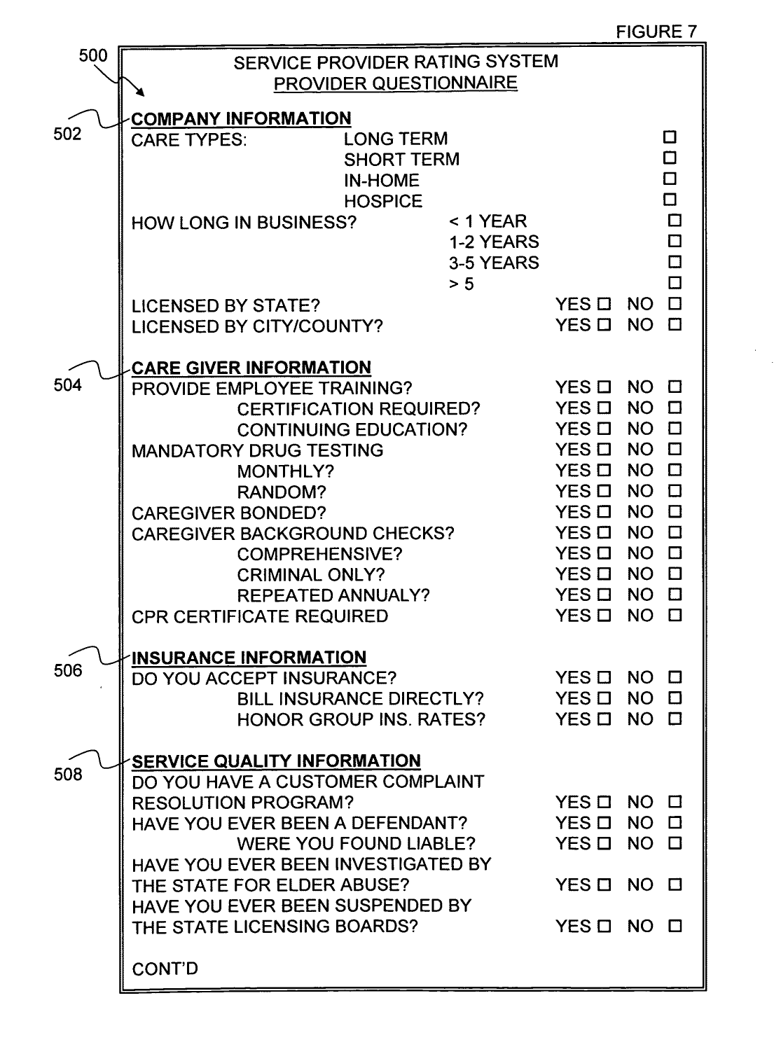

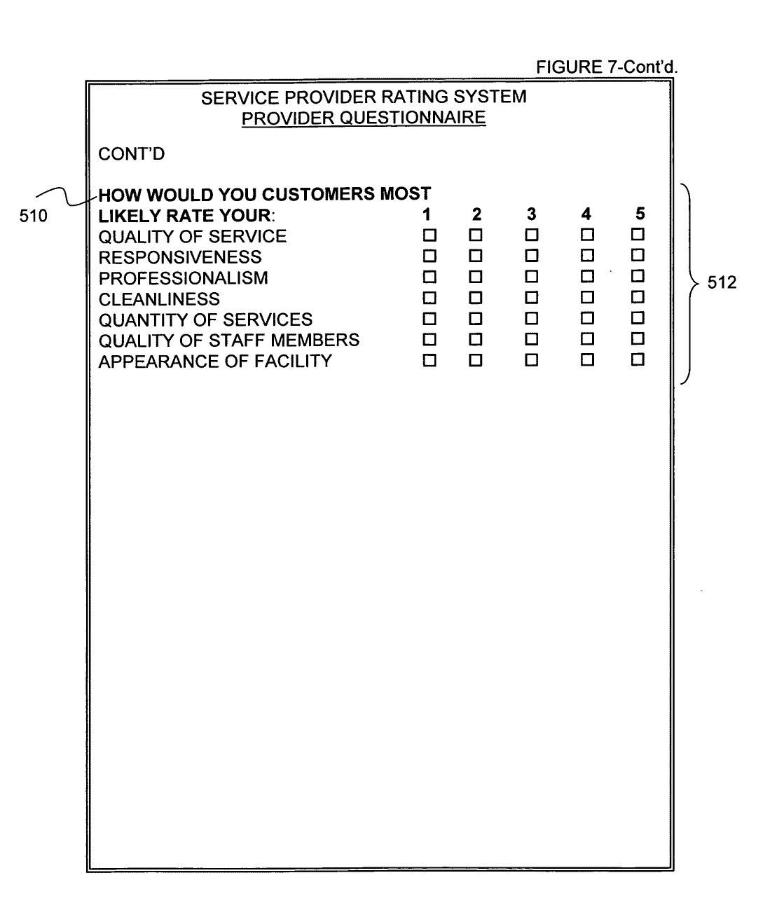

Referring to FIG. 7, a representative provider questionnaire of the service provider feedback collection and rating system of the present invention is shown and generally designated 500. Care provider questionnaire 500 includes some general company information in section 502, such as the types of care provided, and what licensure, if any, exists. Also, in section 504, a collection of questions related to employee training and certification is contained. It may also include information on insurance servicing in section 506, and questions directed to customer service may be included in section 508. A self-evaluation section 510 may also be included which, in this case, may have open-ended questions that provide a range of answers as depicted by 512.

Referring now to FIG. 8, a representative customer search query is shown and generally designated 530. Query 530 is intended to provide the customer the ability to specify preferences in the search process. These preferences may be in the nature of care types 532, such as long term, short term, in-home, or hospice. Other baseline criteria are available in section 534, such as specific evaluation criteria related to employee training, licensing and histories. Also, a specific geographic location may be set forth in section 536.

A very important part of the service provider feedback collection and rating system of the present invention is the ability to search on the various care provider ratings. For instance, in section 538, a prospective customer may search for the highest provider rating, the highest customer rating, or the highest overall rating.

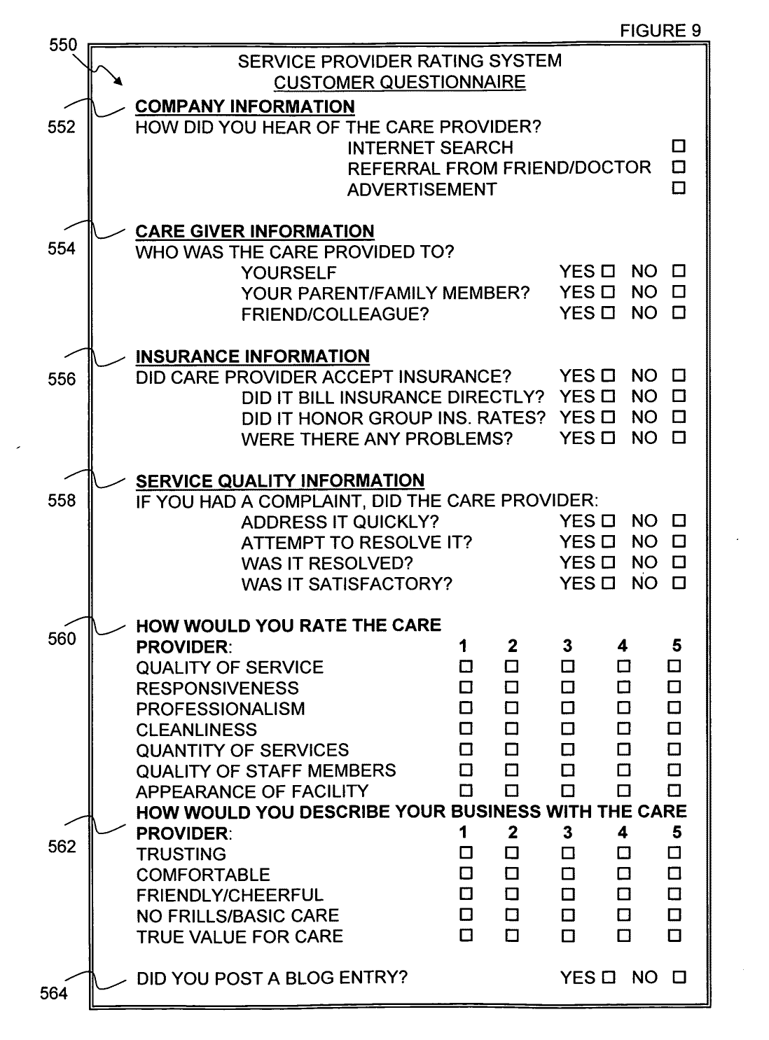

A representative customer questionnaire of the service provider feedback collection and rating system of the present invention is shown in FIG. 9, and generally designated 550. This questionnaire is to be completed by a customer after utilizing the services of a member service provider. Specifically, a customer accesses the central server and completes questionnaire 550 to report on the services received. For instance, general company information may be provided in section 552, and some basic customer information may be provided in section 554. It may be advantageous to avoid providing a customer identity, such as in instances where a patient is currently undergoing treatment by that care provider, or is fearful of retaliation by the provider.

Information related to Insurance service may be provided in section 558, and a personal rating of the care provider may be provided in section 560. For example, the customer's rating, on a one to five scale, may be provided for quality, responsiveness, professionalism, etc. Additionally, in section 562 the customer may rate his or her business dealings with the care provider, such as whether it was a trusting relationship, comfortable, friendly and cheerful, or simply basic care.

One important aspect of the customer questionnaire 550 is the customer's ability to provide a Blog entry to provide more specific commentary regarding the customer's experiences. In section 564, the customer indicates whether he or she has provided a Blog entry, and that entry is uploaded to the care provider profile.

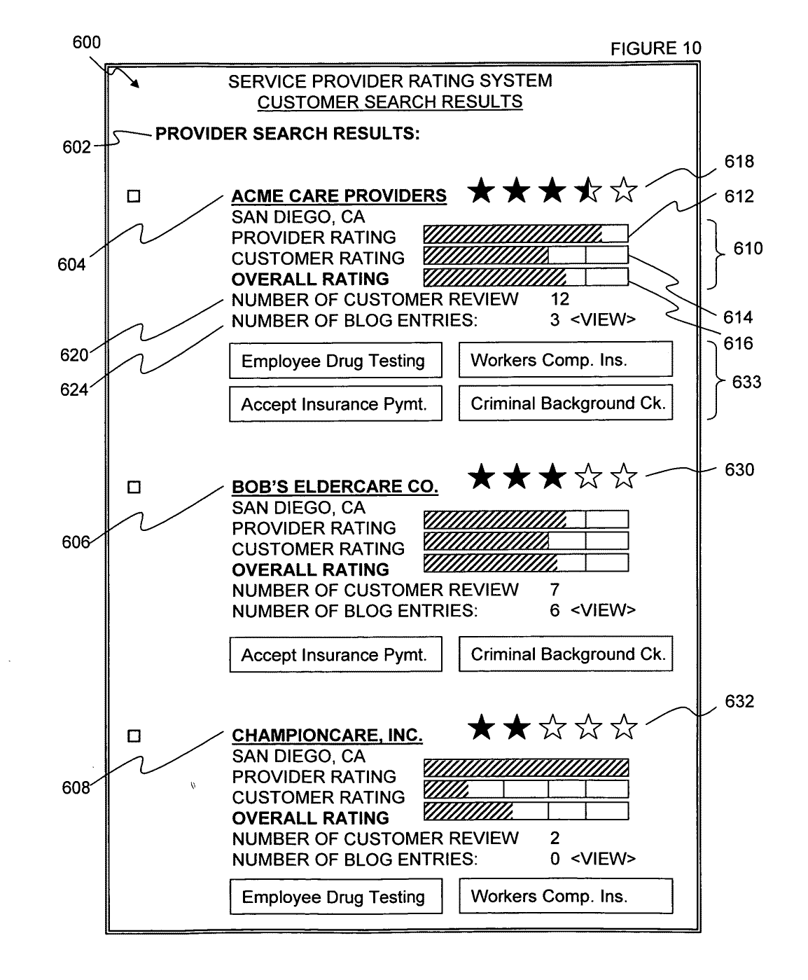

Referring now to FIG. 10, a representative display of the service provider feedback collection and rating system of the present invention is shown and generally designated 600, and includes typical search results from a customer query. More specifically, query search results in section 602 include, for instance, a listing of three care providers 604, 606, and 608, which matched the criteria identified in the customers search query. A three-part rating graph 610 is shown to provide a graphical representation of the provider rating 612, the customer rating 614 and the overall rating 616.

The weighting of the provider rating and the customer rating is very apparent when viewing the listing 608 of Championcare, Inc. In this instance, the provider rating was nearly perfect. This rating is not surprising as the basis for this rating is the provider's own questionnaire. However, the customer rating was very low—almost a 1 on a 5 point scale. Based on the weighted combination of the provider and customer ratings, the overall rating of this care provider is just over 2.

A key aspect of the search results is the star rating scale. For instance, star rating scales 618, 630 and 632 provide a near instantaneous visual indicator for a prospective customer. The star rating scale allows a prospective customer, in an instant, to see which of the care providers listed in the query has the best overall rating. This provides for simple comparison between care providers 604, 606 and 608.

Based on the answers to select questions on the provider questionnaire, provider profiles shown in the search results may include one or more performance notes 633. For instance, if a provider has certain business practices, a brief description of those practices may be presented here. For example, the profile may include performance notes to indicate that the provider has employee drug testing, workers compensation insurance, accepts insurance payments directly, or performs criminal background checks.

Also shown in this Figure, each care provider profile listed on the search results identifies the number of customer reviews that have been entered 612, as well as whether that care provider has been the subject of any Blog entries 614. Each of the customer reviews, as well as all Blog entries, is available for view by prospective customers.

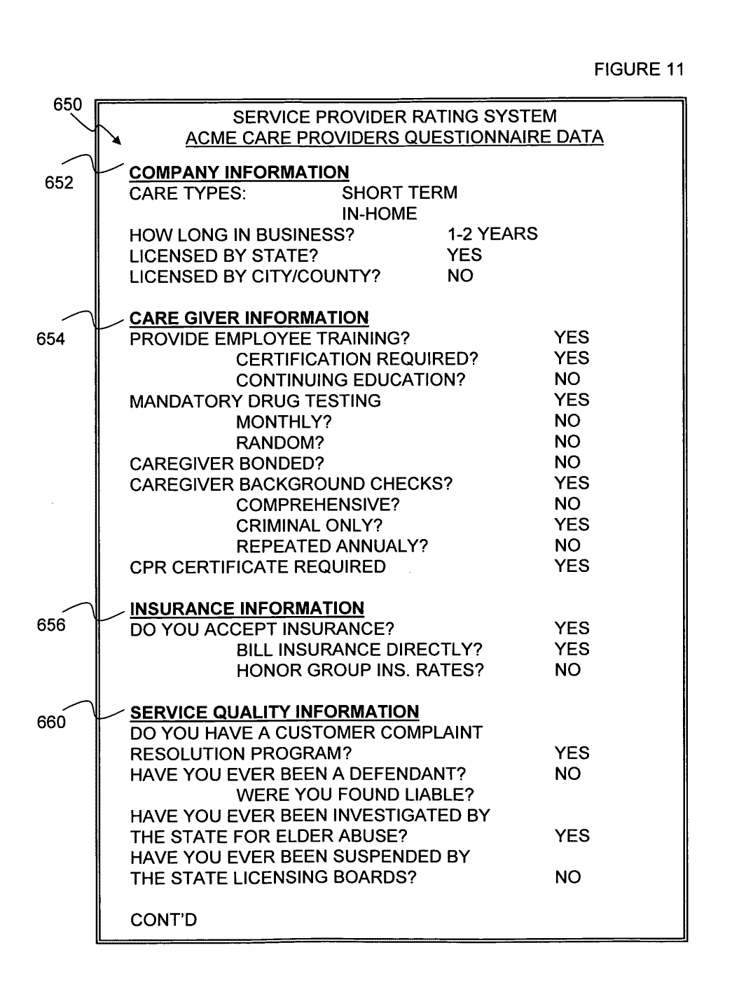

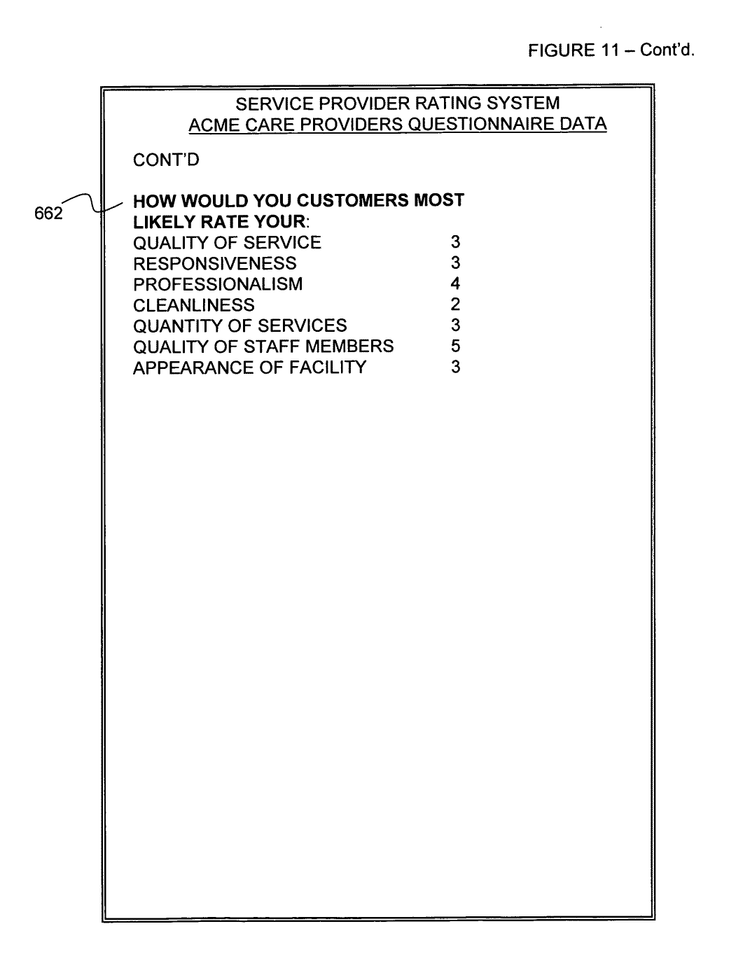

Referring now to FIG. 11, a representative summary of the service provider's data input form is shown and generally designated 650. Form 650 is available for viewing by potential customers, and presents all of the answers which the care provider entered in completing its profile on the system of the present invention. Each of the specific answers is provided for the company information section 652, the care giver information section 654, the insurance information section 656, and the service quality information in section 660. Along with its standard questions, a variety of open ended self-rating questions in section 662 are also provided.

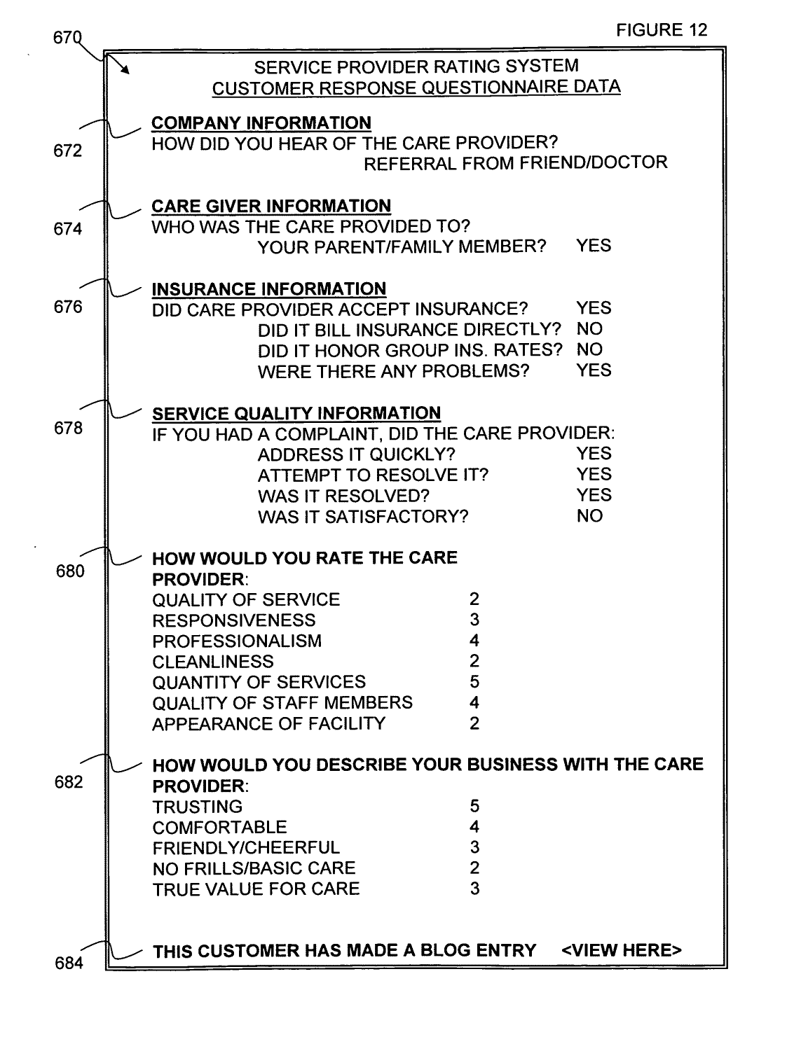

Referring to FIG. 12, a representative summary of the customer response data input form is shown and generally designated 670. Form 670 is available for viewing by potential customers, and includes some basic company and patient information in sections 672 and 674, and some general information related to insurance in section 676.

The customer also provides service quality information in section 678, and then lists the open-ended questions regarding the evaluation of the care provider's services in sections 680 and 682. Also, from this form, the identifier that signals that a Blog entry was made by this reporting customer is shown, and that Blog entry may be viewed by accessing the link.

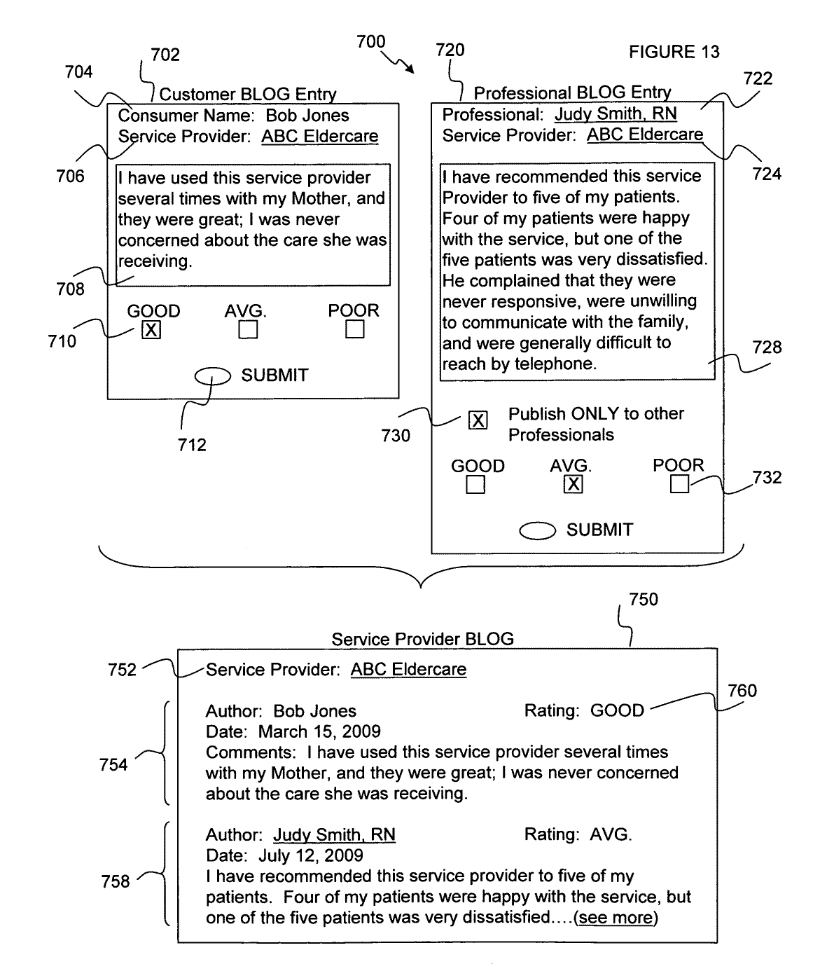

Referring now to FIG. 13, a representative Blog from the service provider feedback collection and rating system of the present invention is shown and generally designated 700. Blog 700 includes a customer Blog entry 702 which may include the customer's name, or identifying information 704. For instance, a customer may utilize his or her own name (e.g. Bob Jones), a consumer identification number, or perhaps a customer nickname (e.g. bjones123), or an email address. In some cases, it may be the customer's decision to post an anonymous Blog entry, in which case the consumer name entry may be left blank.

The service provider is identified in location 706, which may be selected from a pull-down listing of service providers, or it may be manually entered by the customer. A text entry block 708 is provided for the customer to enter his or her Blog entry. Block 708 is a free-form text field within which the customer can enter any comments regarding the service provider. In addition to, or instead of, the information contained in the text entry block 708, grading categories 710 such as GOOD, AVERAGE, and POOR in order to give generalized impressions of the customer's evaluation of the service provider's services. Once the Blog entry is completed, it may be submitted by pressing SUBMIT button 712 which transfers the Blog entry to the central server 102.

A Professional BLOG entry 702 is intended for use by professionals and members of the industry that recommend or evaluate service providers. For instance, nurses, hospital staff, case workers, and social workers could provide Blog entries for service providers that they have had business dealings with. For instance, the Professional's name or identifying information may be entered in field 722, such as Judy Smith, RN. The service provider is identified in location 724, and a text entry block 728 is provided for the professional to enter his or her Blog entry. Block 728 is a free-form text field within which the professional can enter any comments regarding the service provider. In addition to, or instead of, the information contained in the text entry block 728, grading categories 732 such as GOOD, AVERAGE, and POOR in order to give generalized impressions of the professional's evaluation of the service provider's services.

In addition to the text field 728 and the grading categories 732, a professional's Blog entry 720 may include a publication option. For instance, a publication checkbox 730 may be provided which allows the posting professional to publish the Blog entry to all viewers, or only to the other professional viewers. In use, this would provide the professional to limit the dissemination of the Blog entry to only those other professionals. Once the Blog entry is completed, it may be submitted by pressing SUBMIT button which transfers the Blog entry to the central server 102.

When a customer or potential customer wishes to view Blog entries related to a particular service provider, such as by selecting the <VIEW> command on the care provider's profile (see FIG. 10), all Blog entries related to the service provider are displayed, such as the Blog entries 750. These entries, for instance, identify the service provider 752, and then present all or part of the various Blog entries 754 and 758. In a preferred embodiment, the Blog entries may include the overall ratings 760 given in the Blog entries by the customer or professional.

In circumstances where a professional had selected a limit on the publication in box 730, only a professional customer (nurse, caseworker, social worker, hospital administrator, etc) would be provided with the professional Blog entry 758. A customer or potential customer would not be provided the limited publication professional Blog entry 758.

### Operation of the Present Invention

Referring back to FIG. 1, it is to be appreciated that in operation, the service provider feedback collection and rating system of the present invention provides for rating system for a multitude of care providers that can be dynamically updated based on current customer responses. For instance, in operation, a customer 118 may have utilized the services of nursing home 114. The customer then completes a questionnaire on the services received. This questionnaire is analyzed and a customer rating for customer 118's experiences are then made a part of provider 114's profile on central server 102.

Next, patient 120 needs a care provider, and accesses central server 102 to evaluate potential care providers. Patient 120 creates a search query, submits it to central server 102 which then returns hospice 112 as a match. The potential customer may then access hospice 112's profile from the database 106 in central server 102. Within that profile is the care provider's own questionnaire response, as well as the responses from prior customers. These inputs are utilized to calculate, on known criteria and weighting, a provider rating, a customer rating, and an overall rating for that care provider.

This cycle can repeat itself many, many times, with the database simply getting more and more profiles entered. The larger the number of entries in the database, the more statistically significant the results are. For instance, with only a few separate customer questionnaires in a provider's profile, a profile may be considered inadequate to make a truly informed decision regarding the care provider. On the other hand, if there are dozens of customer questionnaires, and several positive Blog entries, a patient or his family may feel relieved and assured that the patient will receive adequate care.

In a preferred embodiment, Blog entries may be monitored by the system administrator of central server 102 to avoid the collection or presentation of obscene or inappropriate content. Also, professionals in groups, such as a collection of nurse or hospital administrators for the same hospital, may require administrative approval prior to the posting of a Blog entry 720.

In a preferred embodiment, a group of users, such as all case managers in the same hospital, may have their accounts within system 100 linked together. This would provide some very useful information since many institutions have many caseworkers, and it is not uncommon for these caseworkers to operate substantially independently of all other case workers in the same facility or group. For instance, one nurse might recommend a service provider based on her own impressions, while another nurse in the same hospital might consider that specific service provider to be substandard.

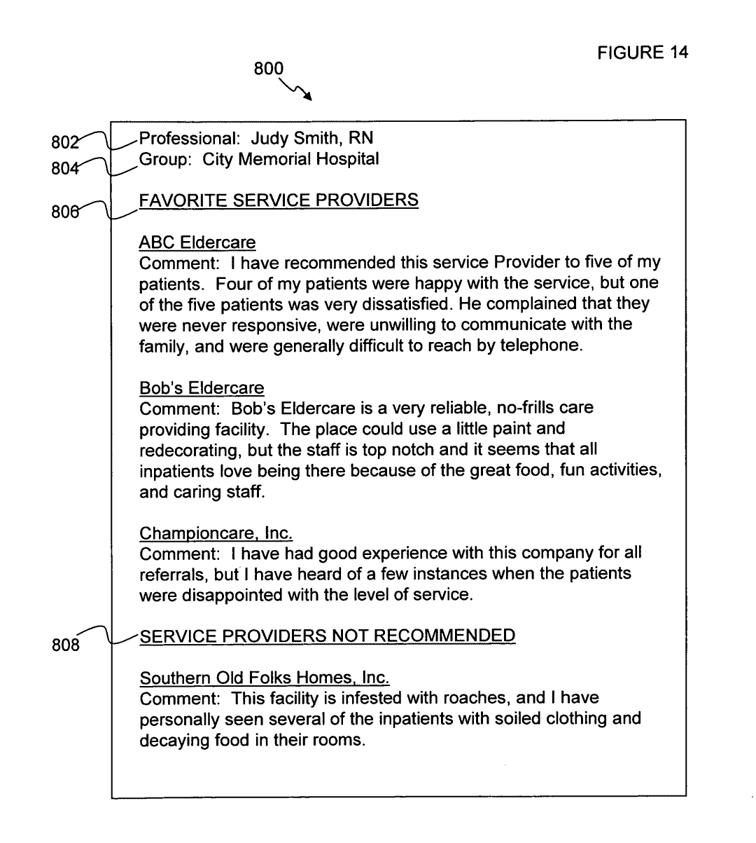

Linking the accounts would provide all members of a group access to the impressions, Blog entries, ratings or comments of all other members in the group. In addition to comments and Blog entries, each professional member may be provided with a “Favorites” page. For instance, referring to FIG. 14, a Favorites page is shown and generally designated 800. Page 800 includes the professional's name or identifying information 802, and a group affiliation 804, such as a hospital, care facility, or any other organization that assists patients and their families in identifying recommending and/or selecting care providers.

Section 806 would include a list of “favorite” care providers, either in orders of preference, type of care provided, and/or in alphabetical order. This section can be customized by the professional to include only those care providers for which he or she has experienced personally, and can include personal notes regarding the impressions he or she may have. In addition to a “favorites” section 806, a separate section for identifying those “non-recommended” service providers may be listed in section 808.

Due to the possibilities of disfavored care providers becoming aggravated by the negative reviews, the administrator for the particular group listed in the group identified in section 804 may exercise some editorial control. Moreover, the professional comments by group members may only be viewed by the other members in the same group, thereby eliminating the chances the negative reviews are published to others outside the group.

By utilizing a group database, a professional within an organization can gain the benefit of the knowledge of his or her peers, and will serve to harmonize recommendations from a group, regardless of the particular group member making the recommendations. Moreover, providing group members access to negative information about particular care providers will serve to improve the level of care patients receive by minimizing the number of patients given the recommendation, and by sending a clear message to the service provider that the industry does not approve of their performance history.

While the service provider feedback collection and rating system of the present invention as herein shown and disclosed in detail is fully capable of obtaining the objects and providing the advantages herein before stated, it is to be understood that it is merely illustrative of preferred and alternative embodiments of the invention and that no limitations are intended to the details of construction or design herein shown other than as described in the appended claims.

1. A service provider evaluation and feedback collection and rating system, comprising:
a central server having a central processing unit and a memory storage device;
a plurality of service provider computers;
a plurality of customer computers;
each said computer interconnected with said central server and each other computer via a network; and
a service provider database maintained on said memory storage device and accessible through said network by said computers, wherein said service provider database comprises data fields corresponding to a plurality of service providers.

2. The service provider evaluation and feedback collection and rating system of claim 1, wherein said memory storage device is selected from random access memory, static read only memory, solid state memory, magnetic memory, and optical media memory.

3. The service provider evaluation and feedback collection and rating system of claim 1, wherein said data fields further comprise a care provider rating.

4. The service provider evaluation and feedback collection and rating system of claim 1, wherein said care provider rating further comprises a visual indicator.

5. The service provider evaluation and feedback collection and rating system of claim 4, wherein said visual indicator further comprises a star rating scale.

6. The service provider evaluation and feedback collection and rating system of claim 1, further comprising a means for collecting care provider data.

7. The service provider evaluation and feedback collection and rating system of claim 6, wherein said means for collecting care provider data further comprises a care provider questionnaire having a plurality of data field, wherein said care provider questionnaire data fields are stored on said memory.

8. The service provider evaluation and feedback collection and rating system of claim 7, wherein said means for collecting care provider data further comprises a patient questionnaire having a plurality of data field, wherein said patient questionnaire data fields are stored on said memory.

9. The service provider evaluation and feedback collection and rating system of claim 8, further comprising a means for determining a care provider rating.

10. The service provider evaluation and feedback collection and rating system of claim 9, wherein said means for determining a care provider rating further comprises combining said patient questionnaire data fields with said care provider data fields.

11. A method for the rating care providers, comprising the steps of:
completing data fields in a care provider questionnaire;
completing data fields in a customer questionnaire;
establishing weighting factors for each said data field; and
calculating an overall provider rating by combining said data fields and said weighting factor.

12. The method of claim 11, further comprising updating a provider profile with said overall provider rating.

13. The method of claim 12, further comprising communicating said overall provider rating to said provider.

14. The method of claim 12, further comprising communicating said overall provider rating to said customer.

15. The method of claim 11, wherein said completing data fields in a care provider questionnaire further comprises collection of compliance with license and certification requirements.

16. The method of claim 11, wherein said completing data fields in a care provider questionnaire further comprises collection employee standards and testing.

17. The method of claim 11, wherein said completing data fields in a customer questionnaire further comprises collection patient services received.

17. The method of claim 11, wherein said completing data fields in a customer questionnaire further comprises collection employee performance and quality.
